(19) United States
(12) Patent Application Publication
(10) Pub. No.: US 2026/0218350 A1
(43) Pub. Date: Jul. 30, 2026

(54) A steel powder mixture for additive manufacturing of a component, preferably for the production of components for machine and vehicle construction

(71) Applicant: DAIMLER TRUCK AG, Leinfelden-Echterdingen (DE)

(72) Inventors: Dieter WILHELM, Ulm (DE); Max RALL, Ulm (DE)

(21) Appl. No.: 19/159,064

(22) PCT Filed: Feb. 2, 2024
(86) PCT No.: PCT/EP2024/052638

§ 371 Date: Aug. 22, 2025

(30) Foreign Application Priority Data
Feb. 27, 2023 (DE) 10 2023 104 661.6

(51) Int. Cl. C22C 38/04; B22F 1/05; B22F 10/28; B33Y 10/00; B33Y 70/00; C22C 38/00; C22C 38/02; C22C 38/06; C22C 38/12; C22C 38/14

(52) U.S. Cl. CPC C22C 38/04; B22F 1/05; B22F 10/28; B33Y 10/00; B33Y 70/00; C22C 38/001; C22C 38/002; C22C 38/02; C22C 38/06; C22C 38/12; C22C 38/14; B22F 2301/35; B22F 2304/10; B22F 2998/10; B22F 2999/00

(57) ABSTRACT

The invention relates to a steel powder mixture for additive manufacturing of a component, preferably for the production of components for machine and vehicle construction, consisting of a low-alloy steel with a high yield strength and yield point, a fracture strength of up to 18%, a tensile strength of up to 900 N/mm² and a hardness of ~30 HRC.

The invention relates to a steel powder mixture for additive manufacturing of a component, preferably for the production of components, for example for machine and vehicle construction, agricultural and forestry machines and steel construction.

It is known to produce components in an additive manufacturing process, also known as 3D printing, in which a selective laser melting (SLM) is employed in the powder bed method. In the process, the component structure is generated by way of a melting and curing, layer-by-layer, of a steel powder mixture that is used.

EP 3 591 078 A1 discloses the use of a steel powder for an additive manufacturing method, with an average grain size of the steel that is provided being from 5-150 μm, the steel consisting of (in wt.-%) of 0.008-0.35% C, up to 0.80% Si, 0.20-2.00% Mn, up to 4.00% Cr, 0.3-3.0% Mo, 0.004-0.020% N, up to 0.40% S, 0.004-0.050% Al, up to 0.0025% B, up to 0.20% Nb, up to 0.02% Ti, up to 0.40% V, up to 1.5% Ni, up to 0.3% Cu, up to 2.0% Co and the remainder of iron and unavoidable impurities, wherein the Al content in % Al, the Nb content in % Nb, the Ti content in % Ti, the V content in % V and the N content in % N of the steel meets the following condition: % Al/27+% Nb/45+% Ti/48+% V/25>% N/3.5.

From WO 2020221812 A1, a steel material in powdered form is known which is used for printing in an additive production method, such as selective laser melting, wherein the material has the following composition: C 0.17-0.23; Si 0.10-0.80; Mn 0.15-0.45, P≤0.03; S≤0.015; Cr 0.8-2.0; Mo 0.15-0.8; Ni 0.1-2.0; V 0.1-2.0, the remainder iron.

These known steel materials are primarily stainless or tool steels that are employed in tool construction.

The object of the invention is to indicate a steel powder mixture for additive manufacturing of a component, the powder mixture meeting the requirements in machine and vehicle construction in particular.

The invention results from the features of the independent claims. Advantageous further developments and configurations are the object of the dependent claims. Further features, possible applications and advantages of the invention follow from the following description and from the explanation of exemplary embodiments of the invention.

The object is achieved with the subject matter of patent claim 1.

The steel powder mixture detailed above consists of a low-alloy steel with a high yield strength and yield point, of at least 800 N/mm², a fracture strength of up to 18%, a tensile strength of up to 900 N/mm² and a hardness of ~30 HRC. Thanks to these characteristics, the powder is especially suitable for producing machine and vehicle parts, agricultural and forestry parts and in steel construction, since no subsequent heat treatment is required. Machines and vehicle parts, agricultural and forestry parts can be produced in any volume, whereby expensive warehousing is no longer an issue. A reduction in the cost of scrap material is also achieved (resource conservation).

Advantageously, the low-alloy steel consists (in wt.-%) of 0.05% C, 0.5% Si, 1.1% Mn, 0.01 P, 0.002% S, 0.01% Al, 0.002% Ti, 0.01% V, 0.06% Nb, 0.04% N and 0.04% O, the remainder of Fe.

In one configuration, the powder has particles with a grain size of 23 μm to 50 μm. In this configuration, the particle size distribution amounts to D10 ~23 μm, D50 ~34.0 μm and D90 ~50 μm.

The components produced in an additive manufacturing process from the steel powder mixture described are very machinable, deformable and are characterized by a very good weldability. They are therefore especially suitable for a hybrid manufacturing process.

A further aspect of the invention relates to a method for generative production of components in which a selective laser melting process is used as a 3D printing process in the powder bed method, the component structure produced in the laser melting process being by way of melting and curing, layer-by-layer, of a steel powder mixture, and a steel powder mixture according to at least one of the features described in this patent application being the one that is used. Such a method facilitates short production times, whereby products produced with this method are ready for further use within a very short time without the need for complicated tool design. It is possible to manufacture the components to customer specifications, which is advantageous. Also, downtimes which occur due to gaps in supplies, as in conventional manufacturing, can thus be bridged.

Bionically adapted products can be created according to individual requirements. The additively manufactured lattice structures reduce the weight of the component. Because the structures are highly complex, selective laser melting, due to its targeted geometric effect in particular, is suitable for the production of additively manufactured lattice structures. The layer-by-layer construction makes it possible for the components to be manufactured to assume any shapes. The method-dependent shaping freedom allows parts to be manufactured which cannot be manufactured in a conventional manner. Furthermore, it is possible for new products to be designed which have performance characteristics that traditional production methods could never achieve.

Further advantages, features and details result from the following description in which at least one exemplary embodiment is described in detail. Features that are described and/or pictorially represented can constitute the object of the invention on their own or in any reasonable combination, optionally even independently of the claims, and in addition can, in particular, also be the object of one or more separate application(s).

Hereinafter, an exemplary embodiment of the steel powder mixture according to the invention is to be explained in Table 1, the powder mixture being used in machine and vehicle construction and agricultural and forestry vehicles, steel construction, etc., for additive manufacturing of components in the 3D printing method. Manufacturing takes place in a powder bed method in which the steel powder mixture is melted and then cured layer-by-layer by a laser beam.

TABLE 1

| | Chemical |
|---|---|
| Chemical | composition |
| elements | in wt.-% |
| C | 0.05 |
| Si | 0.5 |
| Mn | 1.1 |
| P | 0.01 |
| S | 0.002 |
| A | 0.01 |
| Ti | 0.002 |
| V | 0.01 |
| Nb | 0.06 |
| N | 0.04 |
| O | 0.04 |
| Fe | Remainder |

In the process, a particle size distribution arises in which 10% (D10) of the particles are smaller than 23 μm, 50% (D50) of the particles are smaller than 34 μm and 90% (D90) of the particles are smaller than 50 μm.

The metal components manufactured with this steel powder mixture have excellent yield strengths and yield points for the production of machines and vehicle parts. Furthermore, they achieve an elongation at break of up to 18% and a tensile strength of up to 900N/mm². No subsequent heat treatment is required. The metal alloy has a hardness (HRC) of ~30.

1. A steel powder mixture for additive manufacturing of a component, preferably for the production of components for machine and vehicle construction, consisting of a low-alloy steel with a high yield strength and yield point of at least 800 N/mm2, a fracture strength of up to 18%, a tensile strength of up to 900 N/mm2 and a hard-ness of ~30 HRC.

2. The steel powder mixture according to claim 1,
characterized in that
the low-alloy steel consists (in wt.-%) of 0.05% C, 0.5% Si, 1.1% Mn, 0.01 P, 0.002% S, 0.01% Al, 0.002% Ti, 0.01% V, 0.06% Nb, 0.04% N and 0.04% O, the remainder of Fe.

3. The steel powder mixture according to claim 1,
characterized by
particles with a grain size of 23 μm to 50 μm.

4. The steel powder mixture according to claim 1
characterized in that
the powder has a particle size distribution of D10 ~23 μm, D50 ~34.0 μm and D90 ~50 μm.

5. A method for generative production of components in which a selective laser melting process is used as a 3D printing process in the powder bed method, the component structure being produced in the laser melting process by way of melting and curing, layer-by-layer, of a steel powder mixture,
characterized in that
a steel powder mixture according to the preceding claims is used.
